(19) United States
(12) Patent Application Publication
(10) Pub. No.: US 2026/0184166 A1
(43) Pub. Date: Jul. 2, 2026

(54) DISPLAY DEVICE AND VEHICLE HAVING MOUNTED THEREON THE DISPLAY DEVICE

(71) Applicant: HYUNDAI MOBIS CO., LTD., Seoul (KR)

(72) Inventor: Ju Ho Hyun, Yongin-si (KR)

(73) Assignee: HYUNDAI MOBIS CO., LTD., Seoul (KR)

(21) Appl. No.: 19/282,645

(22) Filed: Jul. 28, 2025

(30) Foreign Application Priority Data
Dec. 26, 2024 (KR) 10-2024-0197142

(51) Int. Cl. B60K 35/22; B60R 11/02

(52) U.S. Cl. CPC B60K 35/22; B60R 11/0229; B60K 2360/691; B60K 2360/816

(57) ABSTRACT

A display device includes a cluster module configured to display information about a vehicle, an in-vehicle infotainment (IVI) module disposed adjacent to and adjoining the cluster module and configured to display information manipulable by an occupant, a cover bracket covering the cluster module and the IVI module, and a back cover covering the cover bracket and mounted on the vehicle, in which the cluster module includes an engagement bracket engaged in such a way to be coupled to and separated from the cover bracket and the back cover, thereby facilitating maintenance of an integrated display device including the cluster module and the IVI module.

This application claims the benefit of Korean Patent Application No. 10-2024-0197142, filed on Dec. 26, 2024, which is hereby incorporated by reference as if fully set forth herein.

### BACKGROUND

### Technical Field

The present disclosure relates to a display device to facilitate maintenance of an integrated display device including a cluster module and an in-vehicle infotainment (IVI) module, and a vehicle having mounted thereon the display device.

### Discussion of the Related Art

A center fascia display of a vehicle may display various visual information about the vehicle. As display devices mounted on vehicles have recently become larger, integrated display devices capable of displaying various types of information have been provided.

The integrated display device may implement, for example, a cluster and an in-vehicle infotainment (IVI) display through one display device.

The cluster may display various types of information related to a driving state of the vehicle to a driver. For example, a speed, the number of rotations of an engine, a fuel level, a thermometer, and various warnings of the vehicle may be displayed. The IVI display may display an application that may be manipulated by the driver and an occupant, such as for navigation, media, temperature-related control, etc.

Although convenience of the driver and the occupant has been improved by the integrated display device described above, there may occur difficulty in maintenance. For example, if either the cluster or the IVI display has a failure, the integrated display device needs to be repaired. Depending on circumstances, the integrated display device has to be replaced.

For such reasons, excessive repair and replacement costs may incur, imposing a financial burden on a user. Therefore, there is a need for a means for solving the above-described problems in the integrated display device.

### SUMMARY

The present disclosure provides a display device and a vehicle having mounted thereon the display device, more specifically, aims to provide a display device to facilitate maintenance of an integrated display device including a cluster module and an in-vehicle infotainment (IVI) module, and a vehicle having mounted thereon the display device.

The present disclosure also aims to provide a display device to facilitate maintenance in the event of a failure in either a cluster module or an IVI module by engaging the cluster module in such a way to be coupled to and separated from a cover bracket and a back cover, and a vehicle having mounted thereon the display device.

The technical problems obtainable from the present disclosure are not limited to the technical problems mentioned above, and other technical problems not mentioned will be clearly understood by those of ordinary skill in the art to which the present disclosure belongs from the description below.

According to an aspect of the present disclosure, a display device includes a cluster module configured to display information about a vehicle, an in-vehicle infotainment (IVI) module disposed adjacent to and adjoining the cluster module and configured to display information manipulable by an occupant, a cover bracket covering the cluster module and the IVI module, and a back cover covering the cover bracket and mounted on the vehicle, in which the cluster module includes an engagement bracket engaged in such a way to be coupled to and separated from the cover bracket and the back cover.

The engagement bracket may include a pair of hooks protruding from a back surface thereof to face each other, and the cover bracket and the back cover may include openings into which the pair of hooks are led.

The engagement bracket may be engaged in such a way to be coupled to and separated from the cover bracket and the back cover in a snap-fit manner through the pair of hooks.

The opening of the back cover may include, on an inner surface thereof, a slope formed to allow the pair of hooks to be led therein together.

The back cover may include an engagement surface recessed from a back surface thereof and adjoining the pair of hooks led into the opening.

The pair of hooks may be formed in plural to be spaced apart from each other on the back surface of the engagement bracket.

The cluster module may include a display panel and a cover glass covering a front surface of the display panel, and the engagement bracket may include a coupling surface coupled to a back edge of the cover glass and a bent surface bent backward from the coupling surface to form a step and adjoining the cover bracket.

The engagement bracket may include, on a side thereof, a lead-in groove formed by the coupling surface being bent.

An area of a front portion of the cluster module and an area of a front portion of the IVI module may be different from each other, and a boundary in which the front portion of the cluster module and the front portion of the IVI module adjoin each other may be formed to be inclined.

According to another aspect of the present disclosure, a vehicle includes a vehicle body, a cradling portion disposed on the vehicle body, and a display device mounted on the cradling portion, in which the display device includes a cluster module configured to display information about a vehicle, an in-vehicle infotainment (IVI) module disposed adjacent to and adjoining the cluster module and configured to display information manipulable by an occupant, a cover bracket covering the cluster module and the IVI module, and a back cover covering the cover bracket and mounted on the cradling portion, in which the cluster module includes an engagement bracket engaged in such a way to be coupled to and separated from the cover bracket and the back cover.

### BRIEF DESCRIPTION OF THE DRAWINGS

The accompanying drawings, which are included to provide a further understanding of the disclosure and are incorporated in and constitute a part of this application, illustrate embodiment(s) of the disclosure and together with the description serve to explain the principle of the disclosure. In the drawings:

FIG. 1 shows a display device according to an embodiment of the present disclosure;

FIG. 2 is a view for describing characteristics in which a cluster module is coupled to and separated from a display device according to an embodiment of the present disclosure;

FIG. 3 is an exploded view of a display device according to an embodiment of the present disclosure;

FIG. 4 shows a back surface of a back cover of a display device according to an embodiment of the present disclosure;

FIG. 5 is a cross-sectional view taken along A-A of FIG. 4;

FIG. 6 is an exploded view of a cluster module of a display device according to an embodiment of the present disclosure;

FIG. 7 is a view for describing a shape of an engagement bracket of a display device according to an embodiment of the present disclosure; and

FIG. 8 is a view for describing a lead-in groove formed in an engagement bracket of a display device according to an embodiment of the present disclosure.

### DETAILED DESCRIPTION

Description will now be given in detail according to exemplary embodiments disclosed herein, with reference to the accompanying drawings. The same or equivalent components may be provided with the same reference numbers, and description thereof will not be repeated. As used herein, the suffixes “module” and “part” are added or used interchangeably to facilitate preparation of this specification and are not intended to suggest distinct meanings or functions. In describing embodiments disclosed in this specification, relevant well-known technologies may not be described in detail in order not to obscure the subject matter of the embodiments disclosed in this specification. In addition, it should be noted that the accompanying drawings are only for easy understanding of the embodiments disclosed in the present specification, and should not be construed as limiting the technical spirit disclosed in the present specification. As such, the present disclosure should be construed to extend to any alterations, equivalents and substitutes in addition to those which are particularly set out in the accompanying drawings.

Although the terms first, second, etc. may be used herein to describe various elements, these elements should not be limited by these terms. These terms are generally only used to distinguish one element from another.

It will be understood that when an element is referred to as being “connected with” another element, the element can be directly connected with the other element or intervening elements may also be present. In contrast, it will be understood that when an element is referred to as being “directly connected with” another element, there are no intervening elements present.

A singular representation may include a plural representation unless it represents a definitely different meaning from the context.

The terms such as “include” or “have” used herein are intended to indicate that features, numbers, steps, operations, elements, components, or combinations thereof used in the following description exist and it should be thus understood that the possibility of existence or addition of one or more different features, numbers, steps, operations, elements, components, or combinations thereof is not excluded.

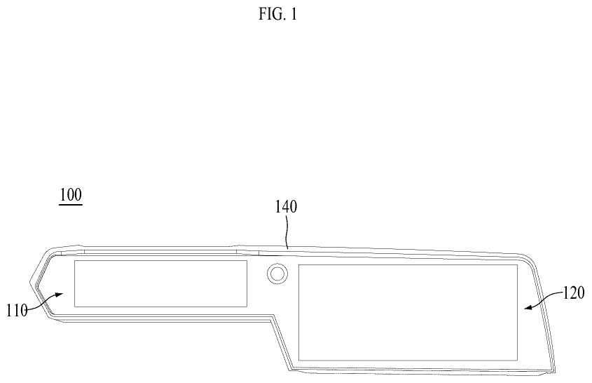

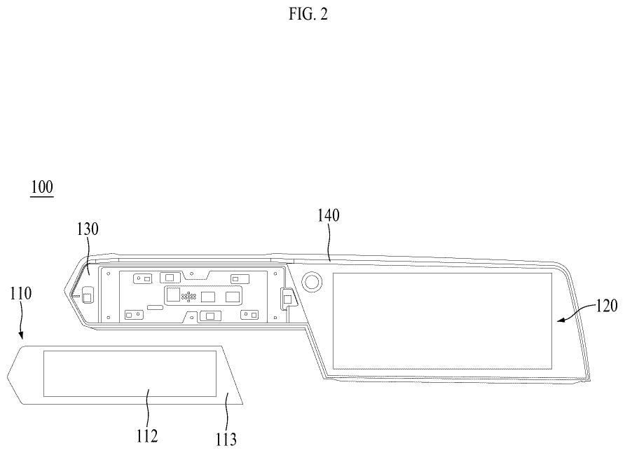

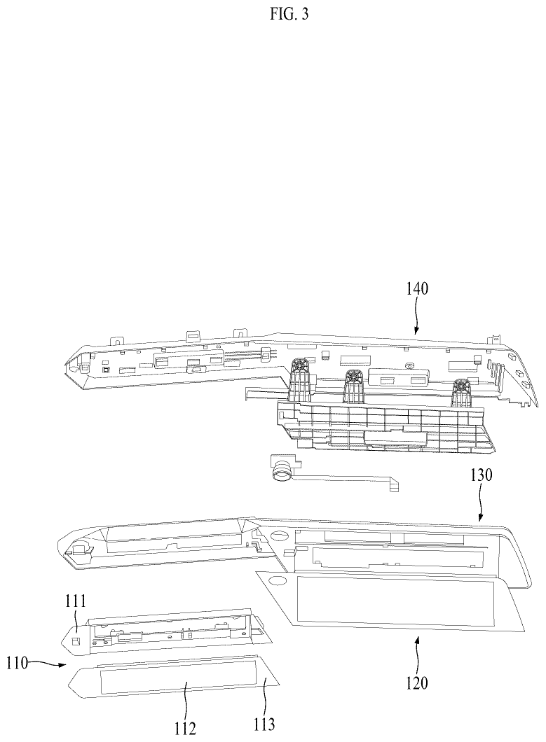

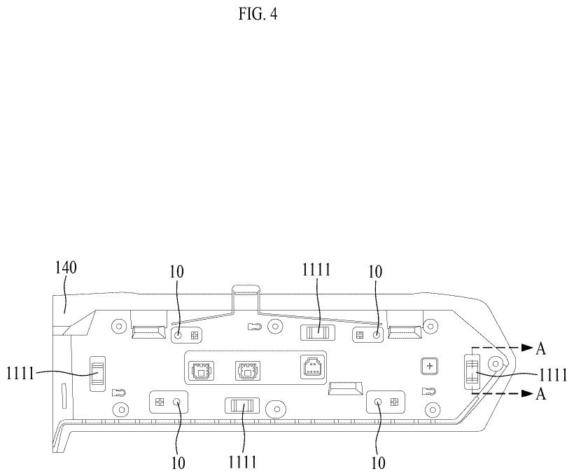

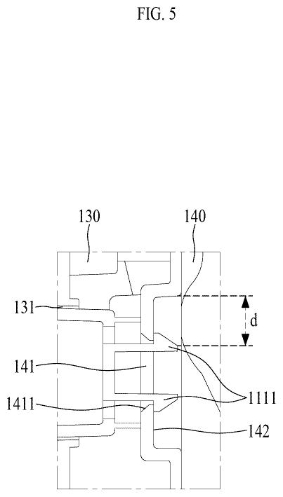

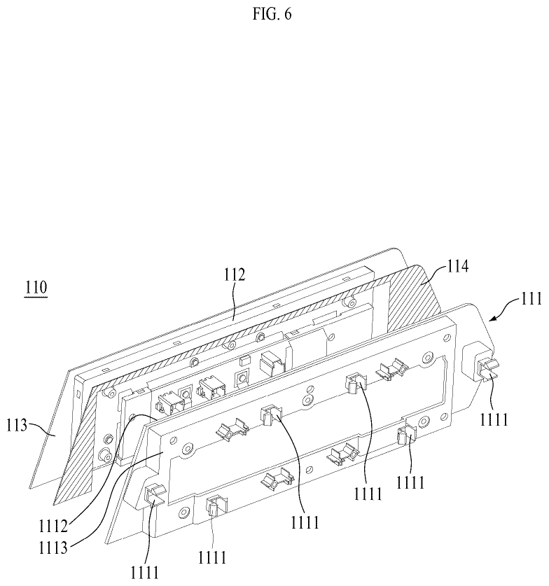

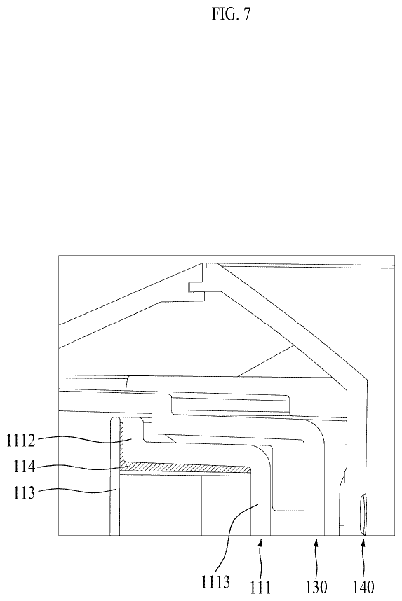

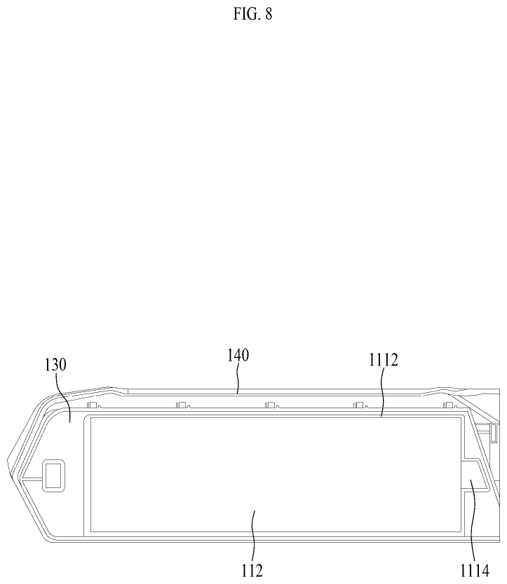

FIG. 1 shows a display device 100 according to an embodiment of the present disclosure. FIG. 2 is a view for describing characteristics in which a cluster module 110 is coupled to and separated from the display device 100 according to an embodiment of the present disclosure. FIG. 3 is an exploded view of the display device 100 according to an embodiment of the present disclosure. FIG. 4 shows a back surface of a back cover 140 of the display device 100 according to an embodiment of the present disclosure. FIG. 5 is a cross-sectional view taken along A-A of FIG. 4. FIG. 6 is an exploded view of the cluster module 110 of the display device 100 according to an embodiment of the present disclosure. FIG. 7 is a view for describing a shape of an engagement bracket 111 of the display device 100 according to an embodiment of the present disclosure. FIG. 8 is a view for describing a lead-in groove 1114 formed in the engagement bracket 111 of the display device 100 according to an embodiment of the present disclosure.

The display device 100 according to an embodiment of the present disclosure may be mounted on a cradle portion disposed on a vehicle body to display various types of visual information to an occupant of the vehicle.

As described above, as display devices mounted on vehicles have recently become larger, integrated display devices capable of displaying various types of information have been provided.

The integrated display device may implement, for example, a cluster and an in-vehicle infotainment (IVI) display through one display device.

The cluster may display various types of information related to a driving state of the vehicle to a driver. For example, a speed, the number of rotations of an engine, a fuel level, a thermometer, and various warnings of the vehicle may be displayed. The IVI display may display an application that may be manipulated by the driver and an occupant, such as for navigation, media, temperature-related control, etc.

Although convenience of the driver and the occupant has been improved by the integrated display device described above, there may occur difficulty in maintenance. For example, if either the cluster or the IVI display has a failure, the integrated display device needs to be repaired. Depending on circumstances, the integrated display device has to be replaced.

For such reasons, excessive repair and replacement costs may incur, imposing a financial burden on a user. Therefore, the display device 100 according to an embodiment of the present disclosure aims to solve the above-described problems.

Referring to FIGS. 1 to 3 together, the display device 100 according to an embodiment of the present disclosure may include the cluster module 110, an IVI module 120, a cover bracket 130, and a back cover 140. As described above, the cluster module 110 may serve to display information about the vehicle, and the IVI module 120 may serve to display information that may be manipulated by an occupant.

As shown in FIG. 3, the cluster module 110 may include a display panel 112 and a cover glass 113 covering a front surface of the display panel 112. The IVI module 120 may also include components corresponding to the cluster module 110.

The IVI module 120 may be disposed adjacent to and adjoin the cluster module 110. That is, the display device 100 according to an embodiment of the present disclosure may be an integrated display device 100 capable of displaying various types of information as the display device 100 becomes larger.

In this case, the cover bracket 130 may be formed integrally and cover the cluster module 110 and the IVI module 120. The back cover 140 may be formed integrally to cover the cover bracket 130, may cover the cover bracket 130 having mounted thereon the cluster module 110 and the IVI module 120, and may be mounted on the vehicle.

In particular, in the display device 100 according to an embodiment of the present disclosure, the cluster module 110 may include the engagement bracket 111 engaged in such a way to be coupled to and separated from the cover bracket 130 and the back cover 140.

Thus, the display device 100 according to an embodiment of the present disclosure may implement the integrated display device 100 as shown in FIG. 1 as the cluster module 110 and the IVI module 120 are mounted on the cover bracket 130 and the back cover 140 that are formed integrally.

As shown in FIG. 3, the cluster module 110 may further include the engagement bracket 111 having mounted thereon the display panel 112 and the cover glass 113, and as show in FIG. 2, the cluster module 110 may be separated separately from the IVI module 120.

In this way, in the event of a failure in either the cluster module 110 or the IVI module 120, the cluster module 110 may be separately separated, thereby improving the efficiency of maintenance.

More specifically, referring to FIGS. 4 and 5 together, in the display device 100 according to an embodiment of the present disclosure, the engagement bracket 111 may include a pair of hooks 1111 protruding from the back surface of the engagement bracket 111 to face each other. The cover bracket 130 and the back cover 140 may include openings 131 and 141 into which the pair of hooks 1111 are led.

Thus, in the display device 100 according to an embodiment of the present disclosure, the cluster module 110 may be engaged in such a way to be easily coupled to and separated from the cover bracket 130 and the back cover 140 through the pair of hooks 1111 formed on the engagement bracket 111 and the openings 131 and 141 formed in the cover bracket 130 and the back cover 140.

The engagement bracket 111 may be engaged in such a way to be coupled to and separated from the cover bracket 130 and the back cover 140 in a snap-fit manner through the pair of hooks 1111. To this end, the pair of hooks 1111 may be formed of a material having elasticity due to an external force.

In the display device 100 according to an embodiment of the present disclosure, the opening 141 of the back cover 140 may include, on an inner surface thereof, a slope 1411 formed such that the pair of hooks 1111 may be led therein together. That is, the engagement bracket 111 may be pushed toward the cover bracket 130 and the back cover 140 through the slope 1411 formed in the opening 141 of the back cover 140 to facilitate coupling.

In the display device 100 according to an embodiment of the present disclosure, the back cover 140 may include an engagement surface 142 recessed from the back surface thereof and adjoining the pair of hooks 1111 led into the opening 141. After the pair of hooks 1111 are led into the opening 141 through the engagement surface 142 formed on the back cover 140, the engagement bracket 111 may be fixed.

In the display device 100 according to an embodiment of the present disclosure, through a distance d from a side of the engagement surface 142 formed on the back cover 140 to the pair of hooks 1111, an operator may easily press the pair of hooks 1111 with fingers. For this reason, the distance d from a side of the engagement surface 142 to the pair of hooks 1111 may be 10 mm or more.

That is, for maintenance of the display device 100 according to an embodiment of the present disclosure, the operator may press the pair of hooks 1111 with fingers through the engagement surface 142 formed on the back surface of the back cover 140 to bring the pair of hooks 1111 together and easily separate the engagement bracket 111 from the cover bracket 130 and the back cover 140.

Moreover, as shown in FIG. 4, in the display device 100 according to an embodiment of the present disclosure, the pair of hooks 1111 may be formed in plural to be spaced apart from each other on the back surface of the engagement bracket 111. Correspondingly, a plurality of openings 131 and 141 may be formed in the cover bracket 130 and the back cover 140.

In the display device 100 according to an embodiment of the present disclosure, the engagement bracket 111 may be engaged to be coupled to and separated from the cover bracket 130 and the back cover 140 through a plurality of screws 10.

Referring to FIGS. 6 to 8 together, in the display device 100 according to an embodiment of the present disclosure, the cluster module 110 may include the display panel 112 and the cover glass 113 that covers the front surface of the display panel 112. The engagement bracket 111 may include a coupling surface 1112 coupled to an edge of a back surface of the cover glass 113. The engagement bracket 111 may be adhered to the cover glass 113 through the adhesive member 114, and a separate jig may be used to adhere the engagement bracket 111 to the cover glass 113.

In the display device 100 according to an embodiment of the present disclosure, the engagement bracket 111 may include a bent surface 1113 bent backward from the coupling surface 1112 to form a step and adjoining the cover bracket 130. The engagement bracket 111 may be stably placed on the cover bracket 130 through the bent surface 1113 formed on the engagement bracket 111.

Moreover, a specific gap may be formed between the coupling surface 1112 of the engagement bracket 111 and the cover bracket 130 through the bent surface 1113 formed on the engagement bracket 111, thereby obtaining a design effect and allowing the engagement bracket 111 to be stably coupled and separated.

Moreover, in the display device 100 according to an embodiment of the present disclosure, the engagement bracket 111 may include, on a side thereof, the lead-in groove 1114 formed by the coupling surface 1112 being bent. As shown in FIG. 8, in a state of the engagement bracket 111 being coupled to the cover bracket 130, the operator may easily separate the engagement bracket 111 from the cover bracket 130 through the lead-in groove 1114.

As shown in FIGS. 1 to 3, in the display device 100 according to an embodiment of the present disclosure, an area of a front portion of the cluster module 110 and an area of a front portion of the IVI module 120 may be different from each other, and a boundary in which the front portion of the cluster module 110 and the front portion of the IVI module 120 adjoin each other may be formed to be inclined. The cover bracket 130 and the back cover 140 may be formed to correspond to sizes and shapes of the front portion of the cluster module 110 and the front portion of the IVI module 120.

With such a shape, the display device 100 according to an embodiment of the present disclosure may be easily mounted on the vehicle. Moreover, mounting of an additional component may be facilitated while securing the degree of freedom of design.

As shown in FIG. 8, the shape may be such a shape that facilitates formation of the lead-in groove 1114 in the engagement bracket 111, and the operator may easily couple and separate the engagement bracket 111 to and from the cover bracket 130 and the back cover 140 for maintenance of the display device 100 according to the present disclosure.

In this way, the display device and the vehicle having mounted thereon the display device according to the present disclosure may facilitate maintenance of the integrated display device including the cluster module and the IVI module. Moreover, maintenance in the event of a failure in either the cluster module or the IVI module may be facilitated by engaging the cluster module in such a way to be coupled to and separated from the cover bracket and the back cover.

The display device and the vehicle having mounted thereon the display device according to the present disclosure may facilitate maintenance of the integrated display device including the cluster module and the IVI module.

Moreover, maintenance in the event of a failure in either the cluster module or the IVI module may be facilitated by engaging the cluster module in such a way to be coupled to and separated from the cover bracket and the back cover.

The effects obtainable from the present disclosure are not limited to the effects mentioned above, and other effects not mentioned will be clearly understood by those skilled in the art to which the present disclosure belongs from the description below.

The above detailed description is to be construed in all aspects as illustrative and not restrictive. The scope of the present disclosure should be determined by reasonable interpretation of the appended claims and all changes coming within the equivalency range of the present disclosure are intended to be embraced in the scope of the present disclosure.

### DESCRIPTION OF REFERENCE NUMERALS

10: Screw
100: Display Device
110: Cluster Module
111: Engagement Bracket
1111: Hook
1112: Coupling Surface
1113: Bent Surface
1114: Lead-in Groove
112: Display Panel
113: Cover Glass
114: Adhesive Member
120: IVI Module
130: Cover Bracket
131: Opening of Cover Bracket
140: Back Cover
141: Opening of Back Cover
1411: Slope
142: Engagement Surface

What is claimed is:

1. A display device comprising:
a cluster module configured to display information about a vehicle;
an in-vehicle infotainment (IVI) module disposed adjacent to and adjoining the cluster module and configured to display information manipulable by an occupant;
a cover bracket covering the cluster module and the IVI module; and
a back cover covering the cover bracket and mounted on the vehicle,
wherein the cluster module comprises an engagement bracket engaged so as to be coupled to and separated from the cover bracket and the back cover.

2. The display device of claim 1,
wherein the engagement bracket includes a pair of hooks protruding from a back surface thereof to face each other, and
wherein the cover bracket and the back cover include openings into which the pair of hooks are led.

3. The display device of claim 2, wherein the engagement bracket is configured to be coupled to and separated from the cover bracket and the back cover in a snap-fit manner through the pair of hooks.

4. The display device of claim 3, wherein the opening of the back cover includes, on an inner surface thereof, a slope formed to allow the pair of hooks to be led therein together.

5. The display device of claim 4, wherein the back cover includes an engagement surface recessed from a back surface thereof and adjoining the pair of hooks led into the opening.

6. The display device of claim 5, wherein the pair of hooks are formed in plural to be spaced apart from each other on the back surface of the engagement bracket.

7. The display device of claim 1,
wherein the cluster module includes:
a display panel; and
a cover glass covering a front surface of the display panel, and wherein the engagement bracket includes:
a coupling surface coupled to a back edge of the cover glass; and
a bent surface bent backward from the coupling surface to form a step and adjoining the cover bracket.

8. The display device of claim 7, wherein the engagement bracket includes, on a side thereof, a lead-in groove formed by the coupling surface being bent.

9. The display device of claim 1,
wherein an area of a front portion of the cluster module and an area of a front portion of the IVI module are different from each other, and
wherein a boundary in which the front portion of the cluster module and the front portion of the IVI module adjoin each other is formed to be inclined.

10. A vehicle comprising:
a vehicle body;
a cradling portion disposed on the vehicle body; and
a display device mounted on the cradling portion,
wherein the display device includes:
a cluster module configured to display information about the vehicle;
an in-vehicle infotainment (IVI) module disposed adjacent to and adjoining the cluster module and configured to display information manipulable by an occupant;
a cover bracket covering the cluster module and the IVI module; and
a back cover covering the cover bracket and mounted on the cradling portion, and
wherein the cluster module includes an engagement bracket engaged so as to be coupled to and separated from the cover bracket and the back cover.

11. The vehicle of claim 10,
wherein the engagement bracket of the cluster module includes a pair of hooks protruding from a back surface thereof to face each other, and
wherein the cover bracket and the back cover of the display device include openings into which the pair of hooks are led.

12. The vehicle of claim 11, wherein the engagement bracket is configured to be coupled to and separated from the cover bracket and the back cover in a snap-fit manner through the pair of hooks.

13. The vehicle of claim 12, wherein the opening of the back cover includes, on an inner surface thereof, a slope formed to allow the pair of hooks to be led therein together.

14. The vehicle of claim 13, wherein the back cover includes an engagement surface recessed from a back surface thereof and adjoining the pair of hooks led into the opening.

15. The vehicle of claim 14, wherein the pair of hooks are formed in plural to be spaced apart from each other on the back surface of the engagement bracket.

16. The vehicle of claim 10,
wherein the cluster module includes:
a display panel; and
a cover glass covering a front surface of the display panel, and the engagement bracket includes:
a coupling surface coupled to a back edge of the cover glass; and
a bent surface bent backward from the coupling surface to form a step and adjoining the cover bracket.

17. The vehicle of claim 16, wherein the engagement bracket includes, on a side thereof, a lead-in groove formed by the coupling surface being bent.

18. The vehicle of claim 10,
wherein an area of a front portion of the cluster module and an area of a front portion of the IVI module are different from each other, and
wherein a boundary in which the front portion of the cluster module and the front portion of the IVI module adjoin each other is formed to be inclined.
